(19) United States
(12) Patent Application Publication
(10) Pub. No.: US 2025/0300533 A1
(43) Pub. Date: Sep. 25, 2025

(54) METHOD FOR BENDING SEGMENT COIL AND DEVICE FOR BENDING SEGMENT COIL

(71) Applicant: HONDA MOTOR CO., LTD., TOKYO (JP)

(72) Inventors: Yasuyuki KIMURA, TOKYO (JP); Keita MIYASHITA, TOKYO (JP); Junya SHIGENO, TOKYO (JP); Mikito SAITO, TOKYO (JP)

(21) Appl. No.: 19/060,709

(22) Filed: Feb. 23, 2025

(30) Foreign Application Priority Data
Mar. 22, 2024 (JP) 2024-045896

(51) Int. Cl. H02K 15/0428

(52) U.S. Cl. CPC H02K 15/0428

(57) ABSTRACT

A method for bending a segment coil includes a first operation of twisting and bending a first coil end row in one circumferential direction and a second operation of twisting and bending, in the other circumferential direction, a second coil end row adjacent to the first coil end row in the radial direction of a stator core. The timing at which the first coil end row reaches the movement completion position through the first operation is made different from the timing at which the second coil end row reaches the movement completion position through the second operation. A device for bending a segment coil performs the method described above.

### CROSS-REFERENCE TO RELATED APPLICATIONS

This application is based upon and claims the benefit of priority from Japanese Patent Application No. 2024-045896 filed on Mar. 22, 2024, the contents of which are incorporated herein by reference.

### BACKGROUND OF THE INVENTION

### Field of the Invention

The present disclosure relates to a method for bending a segment coil and a device for bending segment coil.

### Description of the Related Art

In the manufacturing process of a stator, bending is performed to form the coil ends of segment coils inserted in a stator core into a predetermined shape. In a bending process, adjacent coil end rows among a plurality of coil end rows arranged in a radial direction of the stator core are twisted and bent in the opposite directions in the circumferential direction. JP 3786059 B2 and JP 6798466 B2 disclose a technique for preventing damage to the insulating coating of a segment coil due to contact when the coil ends of adjacent coil end rows pass each other during the bending process.

### SUMMARY OF THE INVENTION

However, in JP 3786059 B2, the segment coil needs to be processed into a special shape. In JP 6798466 B2, a jig used for bending needs to be processed into a special shape. Therefore, it is required to more easily prevent the damage to the insulating coating of the segment coil.

The present disclosure aims to solve the aforementioned problems.

A first aspect of the present disclosure is a method for bending a segment coil, wherein a plurality of coil ends of a plurality of segment coils are inserted in a stator core of a rotary electric machine, project from the stator core in an axial direction of the stator core, and are twisted and bent in a circumferential direction of the stator core, the method including: a first operation of twisting and bending, in one direction of the circumferential direction, a first coil end row that is formed of a plurality of first coil ends arranged in the circumferential direction among the plurality of coil ends; and a second operation, in parallel with the first operation, of twisting and bending, in the other circumferential direction, a second coil end row that is formed of a plurality of second coil ends arranged in the circumferential direction among the plurality of coil ends and is adjacent to the first coil end row in a radial direction of the stator core, wherein the timing at which the first coil end row reaches a movement completion position through the first operation and the timing at which the second coil end row reaches the movement completion position through the second operation are made different from each other.

A second aspect of the present disclosure is a device for a segment coil, the device performing a first operation and a second operation, wherein a plurality of coil ends of a plurality of segment coils are inserted in a stator core of a rotary electric machine, project from the stator core in an axial direction of the stator core, and are twisted and bent in a circumferential direction of the stator core, the first operation of twisting and bending, in a first direction that is one direction of a circumferential direction, a first coil end row that is formed of a plurality of first coil ends arranged in the circumferential direction among the plurality of coil ends, and the second operation, in parallel with the first operation, twists and bends, in a second direction that is another circumferential direction, a second coil end row that is formed of a plurality of second coil ends arranged in the circumferential direction among the plurality of coil ends and is adjacent to the first coil end row in a radial direction of the stator core, the device including: a first jig that is engaged with the first coil end row, a second jig that is engaged with the second coil end row; a first drive unit that rotates the first jig in the first direction to perform the first operation; a second drive unit that rotates the second jig in the second direction to perform the second operation; and a control unit that controls the first drive unit and the second drive unit, wherein the control unit makes different from each other the timing at which the first coil end row reaches a movement completion position through the first operation and the timing at which the second coil end row reaches a movement completion position through the second operation.

According to the present disclosure, the second operation, which is the twisting and bending operation of the second coil end row, is delayed with respect to the first operation, which is the twisting and bending operation of the first coil end row, so that strong contact between the deformed and resultantly most thickened portions of the coil ends can be avoided. Thus, damage to the insulating coating at the deformed and resultantly most thickened portion of the coil end can be prevented. According to the present invention, damage to the insulating coating of the segment coil can be easily prevented.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a segment coil;

FIG. 2 is a perspective view of a stator core and multiple segment coils;

FIG. 3 is a schematic diagram of a bending device according to an embodiment of the present disclosure;

FIG. 4 is a perspective view of a plurality of segment coils that have undergone a twisting-bending process;

FIG. 5 is a diagram for explaining a bending method for a segment coil;

FIG. 6 is a diagram for explaining a time difference between a first operation and a second operation;

FIG. 7 is a diagram for explaining the contact between the bulges of the segment coils;

FIG. 8A is a diagram for explaining the first crossing of segment coils and FIG. 8B illustrates the fifth crossing of segment coils; and

FIG. 9A is a diagram for showing an image of an ideal behavior of the coil ends, FIG. 9B is a diagram for showing an image of an actual behavior of the coil ends in the absence of a time difference, and FIG. 9C is a diagram for showing an image of an actual behavior of the coil ends in the presence of a time difference.

### DETAILED DESCRIPTION OF THE INVENTION

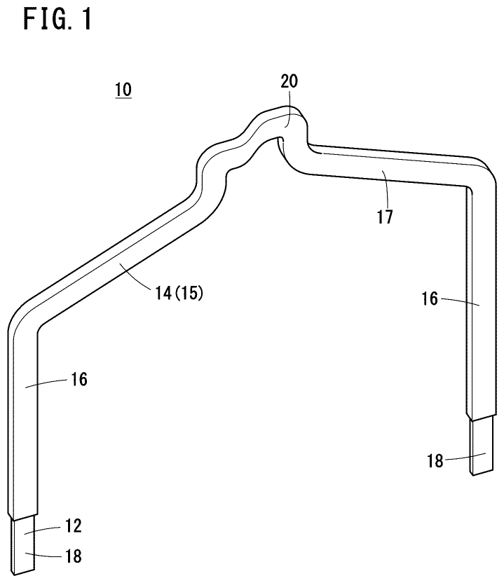

As shown in FIG. 1, a segment coil 10 has a substantially U-shape. The segment coil 10 has a conductor portion 12 and an insulating coating 14. The insulating coating 14 is, for example, enamel or the like. The segment coil 10 has a pair of legs 16 and a turn portion 17. The pair of legs 16 are straight and extend parallel to each other. The tip of each leg 16 is provided with a peeled portion 18 at which the insulating coating 14 is peeled off and thereby the conductor portion 12 is exposed. The portion of the segment coil 10 where the insulating coating 14 is provided is also referred to as “coated portion 15” below. The turn portion 17 is a portion that connects the pair of legs 16 in the segment coil 10. In the turn portion 17, a crank portion 20 having a meander shape is formed.

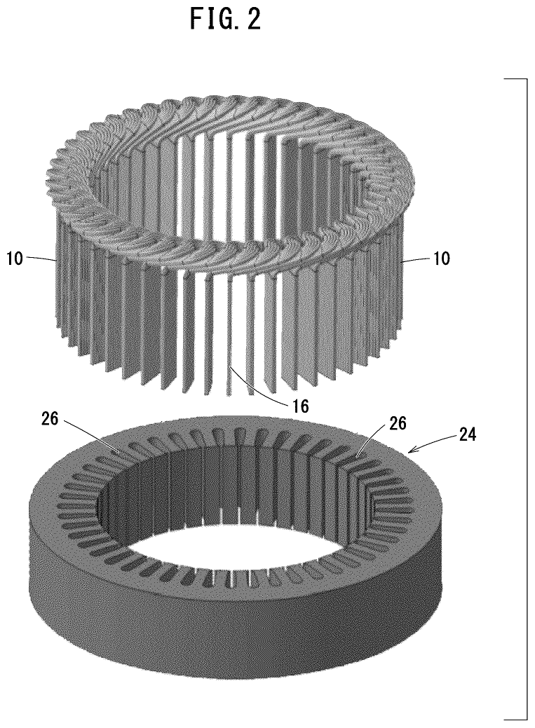

As shown in FIG. 2, a stator core 24 of a rotary electric machine has a plurality of slots 26. In the following description, the circumferential, axial, and radial directions of the stator core 24 are sometimes simply referred to as “circumferential direction”, “axial direction”, and “radial direction”, respectively. In the stator core 24, the slots 26 are provided at intervals in the circumferential direction. The multiple segment coils 10 are inserted into the multiple slots 26. In this case, the pair of legs 16 of the segment coil 10 are inserted into separate slots 26.

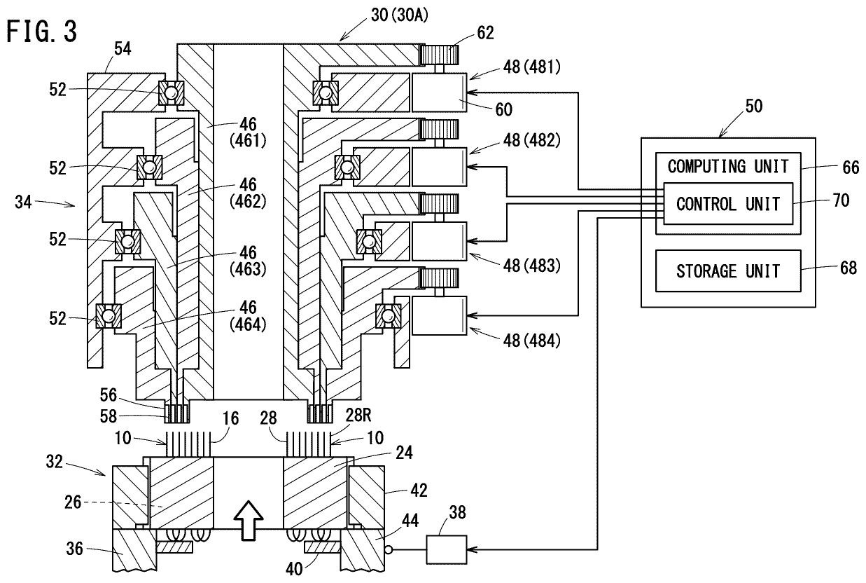

As shown in FIG. 3, with the multiple segment coils 10 being inserted in the stator core 24, the pair of leg 16 of each segment coil 10 project in the axial direction from the slots 26 of the stator core 24 (see also FIG. 2). A portion of each leg 16 that protrudes from the slot 26 is referred to as “coil end 28” hereinafter.

The plurality of segment coils 10 are arranged in the circumferential direction of the stator core 24. The plurality of segment coils 10 are arranged in the radial direction of the stator core 24. Thus, a coil end row 28R is formed by the plurality of coil ends 28 arranged in the circumferential direction. In the stator core 24, a plurality of coil end rows 28R are arranged in the radial direction. In this embodiment, eight coil end rows 28R are arranged in the radial direction. In the following, the radially innermost coil end row 28R is defined as the first layer and the radially outermost coil end row 28R is defined as the eighth layer of the eight coil end rows 28R. That is, the coil end rows 28R of the first to eighth layers are arranged in this order from the inner side to the outer side in the radial direction.

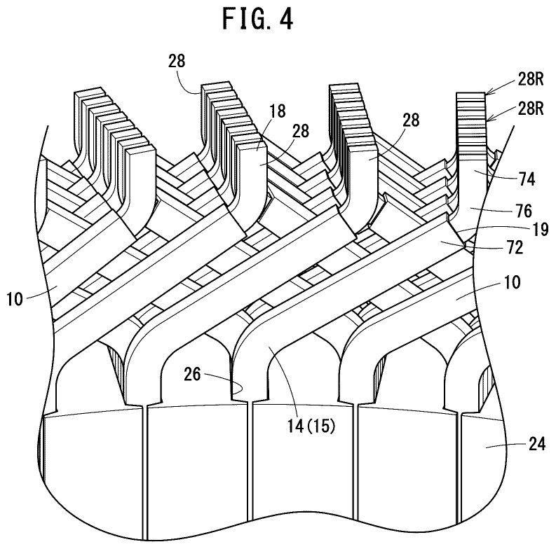

A twisting-bending process (hereinafter, simply referred to as “bending process”) is performed on the plurality of segment coils 10 arranged in this manner. As shown in FIG. 4, the coil end rows 28R adjacent to each other in the radial direction are twisted and bent in the opposite directions in the circumferential direction through the bending process. The twisted and bent coil ends 28 are joined using appropriate methods such as TIG welding between the tips (peeled portions 18) of the coil ends 28 corresponding to each other.

Bending of the plurality of segment coils 10 can be performed using a bending device 30 shown in FIG. 3. The bending device 30 includes a first station 30A and a second station (not shown). The first station 30A performs bending on the outer four layers (fifth to eighth layers) of the segment coils 10. The second station performs bending on the inner four layers (the first to fourth layers) of the segment coils 10. The basic configuration of the second station is similar to that of the first station 30A. Therefore, the following will typically describe the configuration of the first station 30A.

The first station 30A includes an elevating unit 32 and a twisting-bending unit 34. The elevating unit 32 is a mechanism for relatively displacing the stator core 24 and the twisting-bending unit 34 in the axial direction. The elevation unit 32 has an elevation platform 36 and an elevation actuator 38. The elevating platform 36 raises and lowers the stator core 24. The elevating platform 36 includes a substantially ring-shaped mounting board 40, a holding jig 42 for holding the stator core 24, and a base 44 for supporting the mounting board 40 and the holding jig 42. The elevation actuator 38 raises and lowers the base 44. The mounting board 40 and the holding jig 42 are raised and lowered together with the base 44 by the elevating actuator 38. The twisting-bending unit 34 itself may include the mechanism for relatively displacing the stator core 24 and the twisting-bending unit 34 in the axial direction (up-down direction). That is, the twisting-bending unit 34 may have the capability of moving in the axial direction. In this case, the portion holding the stator core 24 does not move in the axial direction.

The twisting-bending unit 34 includes a plurality of twisting-bending jigs 46, a plurality of rotation drive units 48, and a controller 50. The plurality of twisting-bending jigs 46 are jigs for twisting and bending the segment coil 10 by grasping a plurality of coil ends 28 protruding from the slots 26 of the stator core 24. The plurality of twisting-bending jigs 46 engage with the plurality of coil end rows 28R, respectively.

Each of the plurality of twisting-bending jigs 46 has a substantially cylindrical shape. The plurality of twisting-bending jigs 46 are arranged in a concentric manner. The plurality of twisting-bending jigs 46 are supported by a column 54 via a plurality of bearings 52 in a rotatable manner. The plurality of twisting-bending jigs 46 include a first twisting-bending jig 461, a second twisting-bending jig 462, a third twisting-bending jig 463, and a fourth twisting-bending jig 464.

Each of the first twisting-bending jig 461, the second twisting-bending jig 462, the third twisting-bending jig 463 and the fourth twisting-bending jig 464 has an annular holding portion 56 for holding the plurality of coil ends 28. The holding portion 56 is provided at the lower end of each twisting-bending jig 46. A plurality of holding portions 56 are arranged in a concentric manner. The outer periphery of each holding portion 56 is provided with a plurality of circumferentially spaced engagement grooves 58 into which the plurality of coil ends 28 are inserted. Each engagement groove 58 opens radially outward and downward. The radially inward side of each engagement groove 58 is closed.

The plurality of rotation drive units 48 individually rotate the plurality of twisting-bending jigs 46 in the circumferential direction. Each rotation drive unit 48 has a motor 60 and a gear 62. The motor 60 is supported by the column 54. The gear 62 is fixed to an output shaft portion of the motor 60. The plurality of rotation drive units 48 have a first rotation drive unit 481, a second rotation drive unit 482, a third rotation drive unit 483, and a fourth rotation drive unit 484. The first rotation drive unit 481, the second rotation drive unit 482, the third rotation drive unit 483, and the fourth rotation drive unit 484 rotate the first twisting-bending jig 461, the second twisting-bending jig 462, the third twisting-bending jig 463, and the fourth twisting-bending jig 464, respectively.

The plurality of rotation drive units 48 rotate jigs in the opposite directions in the circumferential direction, the jigs being adjacent to each other in the radial direction among the plurality of twisting-bending jigs 46. That is, the rotation directions of the first twisting-bending jig 461 and the third twisting-bending jig 463 rotated by the first rotation drive unit 481 and the third rotation drive unit 483, and the rotation directions of the second twisting-bending jig 462 and the fourth twisting-bending jig 464 rotated by the second rotation drive unit 482 and the fourth rotation drive unit 484 are opposite to each other.

The controller 50 includes a computing unit 66 and a storage unit 68. The computing unit 66 is formed by a processor such as a CPU (Central Processing Unit), a GPU (Graphics Processing Unit), or the like, that is, is formed by processing circuitry.

The computing unit 66 has a control unit 70. The control unit 70 controls the elevation actuator 38 and the plurality of rotation drive units 48. The control unit 70 can be realized by the computing unit 66 executing programs stored in the storage unit 68.

At least part of the control unit 70 may be realized by an integrated circuit such as an ASIC (Application Specific Integrated Circuit), an FPGA (Field-Programmable Gate Array), or the like. In addition, at least part of the control unit 70 may be configured by an electronic circuit including discrete devices.

The storage unit 68 is composed of volatile memory (not shown) and non-volatile memory (not shown). Examples of the volatile memory include, for example, a RAM (Random Access Memory) or the like. The volatile memory is used as working memory of a processor to temporarily store data or the like required for processing or computing operations. Examples of the nonvolatile memory include, for example, a ROM (Read Only Memory), a flash memory, or the like. The non-volatile memory is used as memory for storage, storing programs, tables, maps, etc. At least part of the storage unit 68 may be provided in the above-described processor, integrated circuit, or the like.

The bending device 30 (first station 30A) operates as follows. Here, basic movement of the bending device 30 will be described first.

The control unit 70 raises the elevation platform 36. As a result, the stator core 24 is raised together with the elevating platform 36. As a result of the elevation of the stator core 24, the end coils of the segment coils 10 are inserted into the holding portions 56 (engagement grooves 58) of the twisting-bending jigs 46. Specifically, the fifth layer coil end row 28R is inserted into the holding portion 56 of the first twisting-bending jig 461. The sixth layer coil end row 28R is inserted into the holding portion 56 of the second twisting-bending jig 462. The seventh layer coil end row 28R is inserted into the holding portion 56 of the third twisting-bending jig 463. The eighth layer coil end row 28R is inserted into the holding portion 56 of the fourth twisting-bending jig 464.

In this state, the control unit 70 rotates the first twisting-bending jig 461, the second twisting-bending jig 462, the third twisting-bending jig 463, and the fourth twisting-bending jig 464, thereby twisting and bending the fifth to eighth layer coil end rows 28R in the circumferential direction. In this case, the control unit 70 twists and bends the coil end rows 28R of the fifth and seventh layers in the first direction, which is one circumferential direction, and twists and bends the coil end rows 28R of the sixth and eighth layers in the second direction, which is the other circumferential direction. Regarding the coil end rows 28R that are radially adjacent to each other, the twisting and bending operation of one coil end row 28R is performed in parallel with the twisting and bending operation of the other coil end row 28R.

The coil ends 28 constituting the fifth layer coil end row 28R to the eighth layer coil end row 28R are twisted and bent through such twisting and bending operations. In this case, as shown in FIG. 4, each coil end 28 has a slope portion 72 that slopes with respect to the axial direction and an axial portion 74 that extends along the axial direction. A bent portion 76 is formed between the slope portion 72 and the axial portion 74.

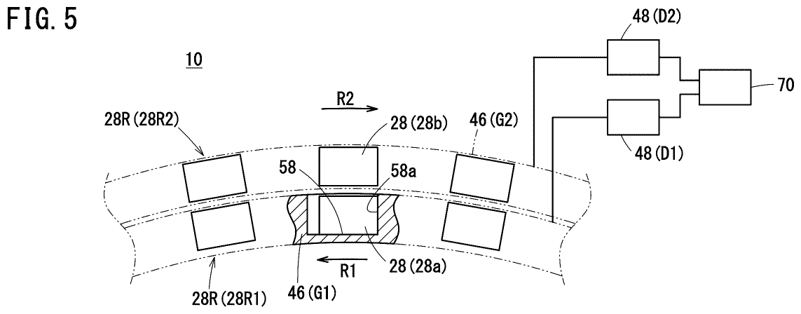

Next, the twisting and bending operation performed by the bending device 30 shown in FIG. 3 will be described in more detail. In the following, as shown in FIG. 5, the explanation will focuses on two coil end rows 28R that are adjacent to each other in the radial direction among the multiple coil end rows 28R. For convenience of explanation, of the coil end rows 28R that are radially adjacent to each other, one coil end row 28R is referred to as a “first coil end row 28R1” and the other coil end row 28R is referred to as a “second coil end row 28R2”. Each of the coil ends 28 constituting the first coil end row 28R1 is referred to as a “first coil end 28a”. Each of the coil ends 28 constituting the second coil end row 28R2 is referred to as a “second coil end 28b”. The second coil end row 28R2 is located further outward in the radial direction of the stator core 24 than the first coil end row 28R1.

The twisting and bending operation by the bending device 30 has a first operation and a second operation. The first operation is an operation of twisting and bending the first coil end row 28R1 in the first direction (R1 direction), which is one circumferential direction. The second operation is an operation of twisting and bending, in parallel with the first operation, the second coil end row 28R2 in the second direction (R2 direction), which is the other circumferential direction. During the progress of the first and second operations, the first coil ends 28a and the second coil ends 28b sequentially pass each other (cross each other). Regarding the twisting-bending jigs 46, one of the twisting-bending jigs 46 adjacent to each other in the radial direction is referred to as “first jig G1”, and the other of the twisting-bending jigs 46 adjacent to each other in the radial direction is referred to as “second jig G2”. Among the rotation drive units 48, the drive unit that rotates the first jig G1 in the first direction so as to perform the first operation is referred to as “first drive unit D1”. Among the rotation drive units 48, the drive unit that rotates the second jig G2 in the second direction so as to perform the second operation is referred to as “second drive unit D2”.

The control unit 70 differentiates the timing at which the first coil end row 28R1 reaches a movement completion position because of the first operation from the timing at which the second coil end row 28R2 reaches a movement completion position because of the second operation. The former timing is also referred to as “first timing” below. The latter timing is also referred to as “second timing”.

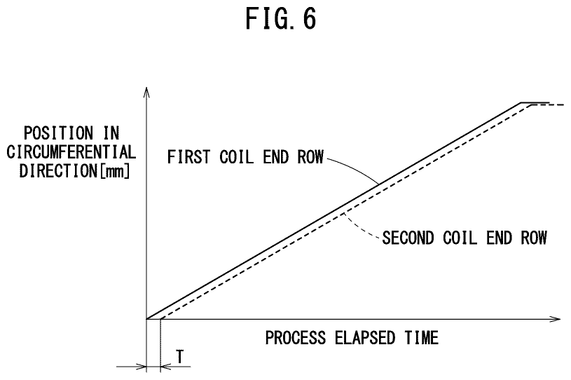

Specifically, the control unit 70 starts the second operation after a delay of a predetermined time difference T from the start of the first operation, as shown in FIG. 6. In this case, the moving speed of the first coil end row 28R1 due to the first operation and the moving speed of the second coil end row 28R2 due to the second operation are the same to each other. Thus, the second coil end row 28R2 reaches the movement completion position later than the first coil end row 28R1. In the case of the bending device 30 shown in FIG. 2, the control unit 70 sequentially shifts by the time difference T the rotation start timings of the first twisting-bending jig 461, the second twisting-bending jig 462, the third twisting-bending jig 463, and the fourth twisting-bending jig 464. The time difference T is, for example, 0.2 seconds or more although it varies depending on the conditions.

The start of the second operation is delayed by the predetermined time difference T from the start of the first operation, whereby it is possible to avoid strong contact between the deformed and thickened portions of the coil ends 28. Therefore, damage to the coated portion 15 at the deformed and thickened portion of the coil end 28 can be prevented. The reasons for this are as follows.

As shown in FIG. 4, the bent portion 76 is formed between the slope portion 72 and the axial portion 74 of the coil end 28 through the bending process. The tip of the coated portion 15 is located at the bent portion 76. In the final stage of the twisting and bending operation for each coil end row 28R, the bending angle between the slope portion 72 and the axial portion 74 reaches the maximum. Thus, at each coil end 28, the tip of the coated portion 15 located at the bent portion 76 is thickest in the radial direction in the final stage of the twisting and bending operation. In particular, a portion of the tip of the coated portion 15 on the rear side with respect to the moving direction of the coil end 28 is thickest.

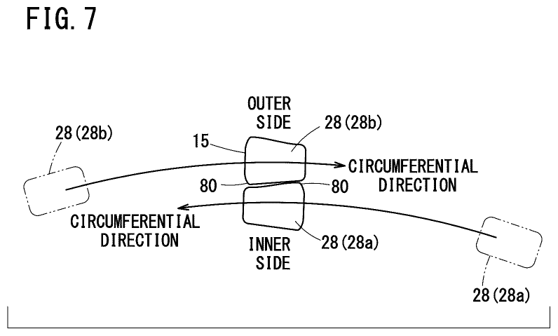

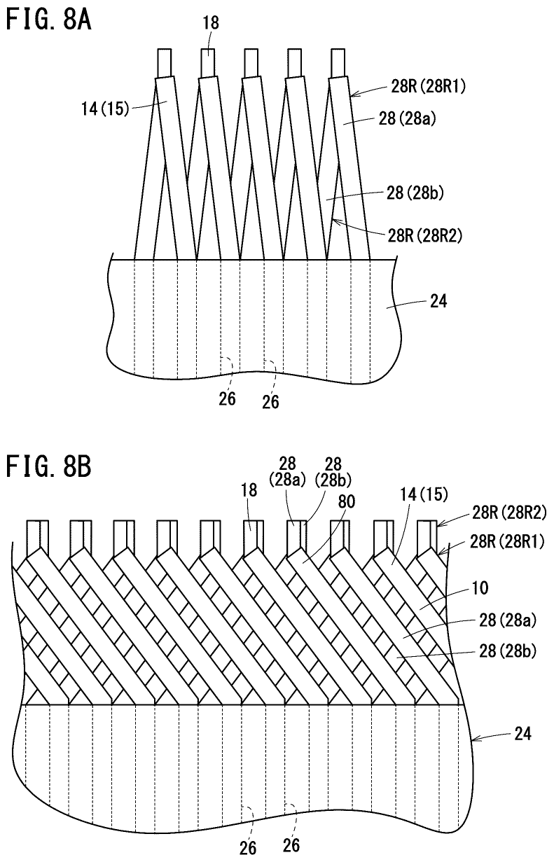

Here, with reference to FIG. 7, the situation in which the peeling of the coated portion 15 may occur will be described. In FIG. 7, a bulge 80 is a portion that has thickened due to bending in the coil end 28 in accordance with the twisting and bending operation. Unlike the present embodiment, when the first timing and the second timing coincide, the bulges 80 strongly contact each other when the first coil end 28a and the second coil end 28b finally pass each other in the final stage of the twisting and bending operation. Because a peeling boundary portion 19 (see FIG. 4), which is the boundary between the coated portion 15 and the peeled portion 18, is located at the bulge 80 of the coil end 28, the peeling of the coated portion 15 can occur due to the strong contact between the bulges 80 of the coil ends 28. Hereinafter, the peeling that can occur by such a mechanism is also referred to as “peeling of the first type”. As shown in FIG. 8B, in the final stage of the twisting and bending operation, each first coil end 28a is in a state of crossing predetermined multiple second coil ends 28b (five in FIG. 8B). The above-mentioned clause “when the first coil end 28a and the second coil end 28b finally pass each other” means the timing when each first coil end 28a crosses the fifth second coil end 28b in FIG. 8B during the progress of the first operation and the second operation. The first coil end row 28R1 and the second coil end row 28R2 are further twisted and bent from the state of FIG. 8B and ultimately twisted and bent into the state shown in FIG. 4.

On the other hand, in a case where the first timing and the second timing are different as in the present embodiment, the second coil end row 28R2 reaches the movement completion position after the first coil end row 28R1 reaches the movement completion position. Thus, the bulges 80 of the coil ends 28 can be prevented from contacting each other in the first coil end 28R1 and the second coil end row 28R2. By avoiding contact between the bulges 80 of the coil ends 28, even when the coil ends 28 rub against each other at another place, it is possible to reduce the surface pressure caused when the friction occurs. This can suppress the peeling (damage) of the coated portion 15, which is the insulating coating 14.

As shown in FIG. 6, the control unit 70 starts the second operation after a delay of the predetermined time difference T from the start of the first operation. In this case, the time difference T is set to a time difference that can prevent the coated portions 15 of the first coil ends 28a and the coated portions 15 of the second coil ends 28b from peeling off when the first coil ends 28a and the second coil ends 28b pass each other for the first time.

Here, the clause “when the first coil ends 28a and the second coil ends 28b pass each other for the first time” refers to the situation shown in FIG. 8A. As shown in FIG. 8A, during the progress of the first and second operations, the first coil end 28a and the second coil end 28b, which project from the slots 26 adjacent to each other in the circumferential direction, pass each other (cross each other). That is, FIG. 8A shows the first crosses concerning each first coil end 28a and each second coil end 28b.

The reason why the time difference T is set as described above is as follows.

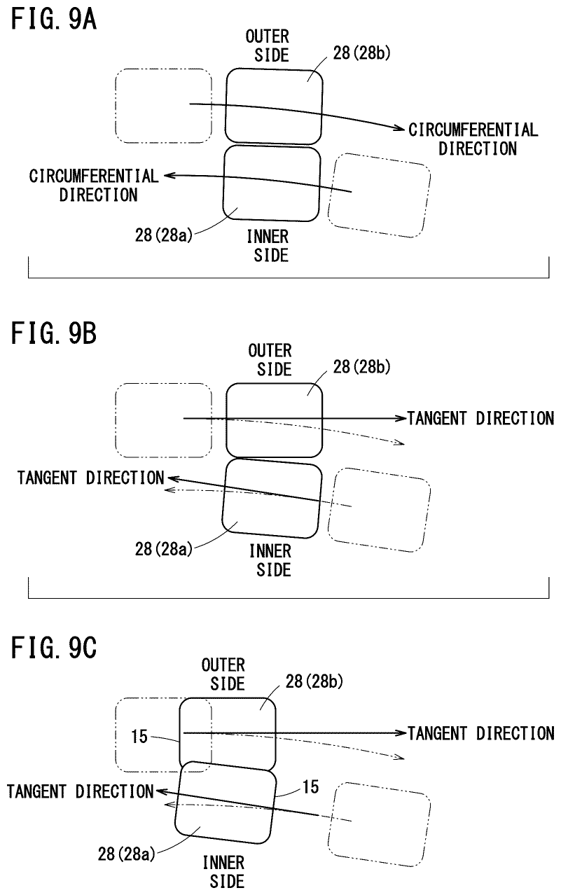

FIGS. 9A to 9C schematically illustrate the situation when the first coil end 28a and the second coil end 28b pass each other for the first time during the progress of the first and second operations. As shown in FIG. 9A, the ideal behavior during the twisting and bending of the first coil end 28a and the second coil end 28b is an arc-like motion along the circumferential direction of the stator core 24. In contrast, as shown in FIGS. 9B and 9C, the actual behaviors during the twisting and bending of the first coil end 28a and the second coil end 28b are different from the ideal behavior in FIG. 9A.

FIG. 9B illustrates the actual behavior of the first and second coil ends 28a and 28b in the absence of the time difference T. The direction in which the first jig G1 (FIG. 5) pushes the first coil end 28a is tangential, and the direction in which the second jig G2 (FIG. 5) pushes the second coil end 28b is tangential. Therefore, when the first coil end 28a and the second coil end 28b pass each other, the first coil end 28a and the second coil end 28b are not parallel to each other, and the relative distance between the first coil end 28a and the second coil end 28b becomes small. The reason why the direction of pressing the first coil end 28a and the second coil end 28b is tangential as described above is as follows. As shown in FIG. 5, the length of the engagement groove 58 in the rotational direction (circumferential direction) of the twisting-bending jig 46 is slightly longer than the front-rear width of the coil end 28. This makes it possible to insert the coil end 28 into the twisting-bending jig 46 without providing any other mechanism. Because the dimensional relationship between the engagement groove 58 and the coil end 28 is as described above, the coil end 28 is not in a state of being guided in the rotational direction (circumferential direction) of the twisting-bending jig 46 when the twisting-bending jig 46 rotates but the coil end 28 is pushed in the tangential direction by the surface 58a of the engagement groove 58, the surface 58a being at the rear side in the traveling direction of the twisting-bending jig 46.

FIG. 9C illustrates the actual behavior of the first and second coil ends 28a and 28b in the presence of the time difference T. Also in this case, the direction in which the first jig G1 pushes the first coil end 28a is tangential and the direction in which the second jig G2 pushes the second coil end 28b is tangential. However, when there is a time difference T, the movement distance of the second coil end 28b with respect to the movement start position when the first coil end 28a and the second coil end 28b pass each other for the first time is smaller than the one when there is no time difference T (FIG. 9B). Thus, the relative distance between the first coil end 28a and the second coil end 28b when they pass each other for the first time is further reduced. Thus, if the time difference T is too large, the coated portion 15 of the first coil end 28a and the coated portion 15 of the second coil end 28b rub against each other strongly when the first coil end 28a and the second coil end 28b pass each other for the first time. The rubbing can cause the peeling of the coated portion 15. Hereinafter, the peeling that can occur through such a mechanism is also referred to as “peeling of the second type”. In the peeling of the second type, peeling is particularly likely to occur on a front side in the moving direction of the coil ends 28—the front side of the tip of the coated portion 15 of each of the coil ends 28 (the peeling boundary portion 19 shown in FIG. 4).

Therefore, in the present embodiment, the time difference T is set to a time difference that can prevent the peeling of the coated portions 15 of the first coil ends 28a and the coated portions 15 of the second coil ends 28b when the first coil ends 28a and the second coil ends 28b pass each other for the first time. By limiting the time difference T in this way, it is possible to suppress the peeling of the second type. The time difference T for preventing the peeling of the second type is, for example, 0.3 seconds or less although it varies depending on the conditions.

A circumferential rotation angle θ of the second coil end row 28R2 with respect to the starting position of the second operation when the first coil ends 28a and the second coil ends 28b pass each other for the first time is preferably 2.0° or more. The rotation angle θ of 2.0° or more can avoid the radial relative distance between the first coil end 28a and the second coil end 28b from becoming too small when the first coil end 28a and the second coil end 28b pass each other for the first time. This can further effectively suppress the peeling of the second type.

Although the above-described one aspect illustrates the aspect in which the second operation is started with a delay of the predetermined time difference T from the start of the first operation, the present invention is not limited to this. For example, the following first or second modified example may be adopted as an aspect in which the first and second operations are started simultaneously.

In the modified example 1, the control unit 70 starts the first operation and the second operation simultaneously. In the modified example 1, the control unit 70 reduces the moving speed of the second coil end row 28R2 between a period after the first coil end 28a and the second coil end 28b pass each other for the first time and before the first coil end 28a and the second coil end 28b pass each other for the last time. Thus, the suppressing of the peeling of both the first type and the second type can be achieved. In other words, the strong contact between the bulges 80 of the coil ends 28 when the first coil end 28a and the second coil end 28b pass each other for the last time is avoided, resulting in that the peeling of the first type can be suppressed. Moreover, since the first and second operations are started simultaneously, the peeling of the second type can also be suppressed.

In the second modified example, the control unit 70 starts the first operation and the second operation simultaneously. In the modified example 2, the control unit 70 moves the second coil end row 28R2 at a speed slower than the moving speed of the first coil end row 28R1 so as to avoid the strong contact between the bulges 80 when the first coil end 28a and the second coil end 28b pass each other for the last time. This avoids strong contact between the bulges 80 of the coil ends 28 when the first coil end 28a and the second coil end 28b pass each other for the last time, and it is possible to suppress the peeling of the first type. In this case, in order to suppress the peeling of the second type, the difference between the moving speed of the first coil end row 28R1 and the moving speed of the second coil end row 28R2 is set so that the relative distance in the radial direction between the first coil end 28a and the second coil end 28b when the first coil end 28a and the second coil end 28b pass each other for the first time is not too small.

With respect to the above embodiments, the following supplementary notes are further disclosed.
(Supplementary note 1) A method for bending a segment coil (10), wherein a plurality of coil ends (28) of a plurality of segment coils are inserted in a stator core (24) of a rotating electric machine, project from the stator core in the axial direction of the stator core, and are twisted and bent in the circumferential direction of the stator core, includes a first operation of twisting and bending, in one direction of the circumferential direction, a first coil end row (28R1), that is formed of a plurality of first coil ends (28a) arranged in the circumferential direction among the plurality of coil ends; a second operation of twisting and bending, in parallel with the first operation, in the other direction in the circumferential direction, a second coil end row (28R2) that is formed of a plurality of second coil ends (28b) arranged in the circumferential direction among the plurality of coil ends and is adjacent to the first coil end row in the radial direction of the stator core, wherein the timing at which the first coil end row reaches a movement completion position through the first operation and the timing at which the second coil end row reaches a movement completion position through the second operation are made different from each other.
(Supplementary note 2) Regarding the bending method of segment coil according to Supplementary note 1, the second operation may be started after a predetermined time difference (T) from the start of the first operation.
(Supplementary note 3) Regarding the method for bending a segment coil according to Supplementary note 2, the second coil end row may be arranged further outward in a radial direction of the stator core than the first coil end row, during a progress of the first operation and the second operation, the plurality of first coil ends and the plurality of second coil ends sequentially may pass each other, and the time difference may be a time difference that prevents coated portions (15) of the first coil ends and coated portions of the second coil ends from peeling off when the first coil ends and the second coil ends pass each other for the first time.
(Supplementary note 4) In the bending method for segment coils according to Supplementary note 3, the rotation angle (θ) of the second coil end row in the circumferential direction with respect to the start position of the second motion when the first coil ends and the second coil ends first pass each other may be 2.0° or more.
(Supplementary note 5) A device (30) for bending a segment coil performs a first operation and a second operation wherein a plurality of coil ends of a plurality of segment coils are inserted in a stator core of a rotary electric machine, project from the stator core in an axial direction of the stator core, and are twisted and bent in a circumferential direction of the stator core, the first operation twists and bends, in a first direction that is one direction of a circumferential direction, a first coil end row that is formed of a plurality of first coil ends arranged in the circumferential direction among the plurality of segment coils, the second operation, in parallel with the first operation, twists and bends, in a second direction that is another circumferential direction, a second coil end row that is formed of a plurality of second coil ends arranged in the circumferential direction among the plurality of coil ends and is adjacent to the first coil end row in a radial direction of the stator core, and the device includes a first jig (G1) that is engaged with the first coil end row, a second jig (G2) that is engaged with the second coil end row, a first drive unit (D1) that rotates the first jig in the first direction to perform the first operation, a second drive unit (D2) that rotates the second jig in the second direction to perform the second operation, and a control unit (70) that controls the first drive unit and the second drive unit, wherein the control unit makes different from each other the timing at which the first coil end row reaches a movement completion position through the first operation and the timing at which the second coil end row reaches a movement completion position through the second operation.
(Supplementary note 6) Regarding the device according to Supplementary note 5, the control unit may start the second operation after a predetermined time difference from the start of the first operation.
(Supplementary note 7) Regarding the device according to Supplementary note 6, during the progress of the first operation and the second operation, the plurality of first coil ends and the plurality of second coil ends may sequentially pass each other, the second coil end row may be arranged further outward in a radial direction of the stator core than the first coil end row, and the time difference may be a time difference that prevents coated portions of the first coil ends and coated portions of the second coil ends from peeling off when the first coil ends and the second coil ends first pass each other.
(Supplementary note 8) Regarding the device according to Supplementary note 7, the time difference may be a time difference set in a manner so that a rotation angle of the second coil end row in the circumferential direction with respect to a start position of the second operation when the first coil ends and the second coil ends first pass each other may be 2.0° or more.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A method for bending a segment coil wherein a plurality of coil ends of a plurality of the segment coils are inserted in a stator core of a rotary electric machine, project from the stator core in an axial direction of the stator core, and are twisted and bent in a circumferential direction of the stator core, the method comprising:
a first operation of twisting and bending, in one direction of the circumferential direction, a first coil end row that is formed of a plurality of first coil ends arranged in the circumferential direction among the plurality of coil ends; and
a second operation, in parallel with the first operation, of twisting and bending, in another circumferential direction, a second coil end row that is formed of a plurality of second coil ends arranged in the circumferential direction among the plurality of coil ends and is adjacent to the first coil end row in a radial direction of the stator core,
wherein a timing at which the first coil end row reaches a movement completion position through the first operation and a timing at which the second coil end row reaches a movement completion position through the second operation are made different from each other.

2. The method for bending the segment coil according to claim 1, wherein
the second operation is started after a predetermined time difference from start of the first operation.

3. The method for bending the segment coil according to claim 2, wherein
the second coil end row is arranged further outward in a radial direction of the stator core than the first coil end row,
during a progress of the first operation and the second operation, the plurality of first coil ends and the plurality of second coil ends sequentially pass each other, and
the time difference is a time difference that prevents coated portions of the first coil ends and coated portions of the second coil ends from peeling off when the first coil ends and the second coil ends pass each other for the first time.

4. The method for bending the segment coil according to claim 3, wherein
a rotation angle of the second coil end row in the circumferential direction with respect to a start position of the second operation when the plurality of the first coil ends and the plurality of the second coil ends pass each other for the first time is 2.0° or more.

5. A device for bending a segment coil, the device performing a first operation and a second operation,
wherein
a plurality of coil ends of a plurality of the segment coils are inserted in a stator core of a rotary electric machine, project from the stator core in an axial direction of the stator core, and are twisted and bent in a circumferential direction of the stator core,
the first operation twists and bends, in a first direction that is one direction of a circumferential direction, a first coil end row that is formed of a plurality of first coil ends arranged in the circumferential direction among the plurality of coil ends, and
the second operation, in parallel with the first operation, twists and bends, in a second direction that is another circumferential direction, a second coil end row that is formed of a plurality of second coil ends arranged in the circumferential direction among the plurality of coil ends and is adjacent to the first coil end row in a radial direction of the stator core,
the device comprising:
a first jig that is engaged with the first coil end row;
a second jig that is engaged with the second coil end row;
a first drive unit that rotates the first jig in the first direction to perform the first operation;
a second drive unit that rotates the second jig in the second direction to perform the second operation; and
a control unit that controls the first drive unit and the second drive unit,
wherein
the control unit includes a processor that executes computer-executable instructions stored in memory, and
the processor executing the computer-executable instructions to cause the control unit to make different from each other a timing at which the first coil end row reaches a movement completion position through the first operation and a timing at which the second coil end row reaches a movement completion position through the second operation.

6. The device for bending the segment coil according to claim 5, wherein
the control unit starts the second operation after a predetermined time difference from start of the first operation.

7. The device for bending the segment coil according to claim 6, wherein
during a progress of the first operation and the second operation, the plurality of first coil ends and the plurality of second coil ends sequentially pass each other,
the second coil end row is arranged further outward in the radial direction of the stator core than the first coil end row,
the time difference is a time difference that prevents coated portions of the first coil ends and coated portions of the second coil ends from peeling off when the first coil ends and the second coil ends pass each other for the first time.

8. The device for bending the segment coil according to claim 7, wherein
the time difference is a time difference set in a manner so that a rotation angle of the second coil end row in the circumferential direction with respect to a start position of the second operation when the first coil ends and the second coil ends pass each other for the first time is 2.0° or more.
